(19) United States
(12) Patent Application Publication
(10) Pub. No.: US 2026/0228544 A1
(43) Pub. Date: Aug. 6, 2026

(54) SYSTEM AND METHOD FOR MULTI-MODAL ANNOTATION

(71) Applicant: TOYOTA RESEARCH INSTITUTE, INC., Los Altos, CA (US)

(72) Inventors: Xiongyi CUI, Somerville, MA (US); Emily S. SUMNER, Cambridge, MA (US); Jonathan A. DECASTRO, Arlington, MA (US); Deepak EDAKKATTIL GOPINATH, Washington, DC (US); Andrew M. SILVA, Cambridge, MA (US); Thomas M. BALCH, Damariscotta, MA (US); Guy ROSMAN, Newton, MA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 19/044,480

(22) Filed: Feb. 3, 2025

(51) Int. Cl. G06N 3/091; G06N 3/0475

(52) U.S. Cl. CPC G06N 3/091; G06N 3/0475

(57) ABSTRACT

A method for multi-modal annotation is described. The method includes generating, using a training data generation model, a pre-annotated training data for human annotations. The method also includes iteratively verifying the human annotations of the pre-annotated training data using a different annotator from a human annotator or the human annotations. The method further includes adjusting the human annotations of the pre-annotated training data based on interactively verifying to finalize an annotated training data. The method also includes training a machine learning model using the annotated training data.

### BACKGROUND

### Field

Certain aspects of the present disclosure relate to autonomous vehicle technology and, more particularly, to a system and method for a multi-modal annotation tool.

### Background

Autonomous agents (e.g., vehicles, robots, etc.) rely on machine vision for sensing a surrounding environment by analyzing areas of interest in a scene from images of the surrounding environment. Although scientists have spent decades studying the human visual system, a solution for realizing equivalent machine vision remains elusive. Realizing equivalent machine vision is a goal for enabling truly autonomous agents. Machine vision, however, is distinct from the field of digital image processing. In particular, machine vision involves recovering a three-dimensional (3D) structure of the world from images and using the 3D structure for fully understanding a scene. That is, machine vision strives to provide a high-level understanding of a surrounding environment, as performed by the human visual system.

Autonomous agents, such as driverless cars and robots, are quickly evolving and have become a reality in this decade. Because autonomous agents have to interact with humans, however, many critical concerns arise. For example, how to design vehicle control of an autonomous vehicle using machine learning. Unfortunately, vehicle control by machine learning is less effective in complicated traffic environments involving complex interactions between vehicles (e.g., a situation where a controlled (ego) vehicle merges/changes onto/into a traffic lane).

Machine learning to train these autonomous agents often involves large, labeled datasets to reach state-of-the-art performance. Unfortunately, acquiring enough labels to train autonomous agents can be laborious and costly, as it mostly relies on a large number of human annotators. Additionally, the cost of annotating varies greatly with the annotation type because 3D bounding boxes are much cheaper and faster to annotate than, for example, instance segmentations or cuboids.

### SUMMARY

A method for multi-modal annotation is described. The method includes generating, using a training data generation model, a pre-annotated training data for human annotations. The method also includes iteratively verifying the human annotations of the pre-annotated training data using a different annotator from a human annotator or the human annotations. The method further includes adjusting the human annotations of the pre-annotated training data based on interactively verifying to finalize an annotated training data. The method also includes training a machine learning model using the annotated training data.

A non-transitory computer-readable medium having program code recorded thereon for multi-modal annotation is described. The program code is executed by a processor. The non-transitory computer-readable medium includes program code to generate, using a training data generation model, a pre-annotated training data for human annotations. The non-transitory computer-readable medium also includes program code to iteratively verify the human annotations of the pre-annotated training data using a different annotator from a human annotator or the human annotations. The non-transitory computer-readable medium further includes program code to adjust the human annotations of the pre-annotated training data based on interactively verifying to finalize an annotated training data. The non-transitory computer-readable medium also includes program code to train a machine learning model using the annotated training data.

A system for multi-modal annotation is described. The system includes a training data generation model to generate, using a training data generation model, a pre-annotated training data for human annotations. The system also includes an annotated data verification model to iteratively verify the human annotations of the pre-annotated training data using a different annotator from a human annotator or the human annotations. The system further includes an annotated data modification model to adjust the human annotations of the pre-annotated training data based on interactively verifying to finalize an annotated training data. The system also includes a model training module to train a machine learning model using the annotated training data.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation using a system-on-a-chip (SOC) for a multi-modal annotation system, in accordance with aspects of the present disclosure.

FIG. 2 is a block diagram illustrating a software architecture that may modularize artificial intelligence (AI) functions for a multi-modal annotation system, according to aspects of the present disclosure.

FIG. 3 is a diagram illustrating an example of a hardware implementation for a multi-modal annotation system, according to aspects of the present disclosure.

FIGS. 4A-4B are block diagrams illustrating a vehicle trained using training data generated with a multi-modal annotation system, according to aspects of the present disclosure.

FIG. 5 is a block diagram illustrating a multi-modal annotation process, according to various aspects of the present disclosure.

FIG. 6 illustrates scenario data for annotation, according to various aspects of the present disclosure.

FIG. 7 is a flowchart illustrating a method for a multi-modal annotation process, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although

some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents (e.g., vehicles, robots, etc.) rely on machine vision for sensing a surrounding environment by analyzing areas of interest in a scene from images of the surrounding environment. Although scientists have spent decades studying the human visual system, a solution for realizing equivalent machine vision remains elusive. Machine vision involves recovering a three-dimensional (3D) structure of the world from images and using the 3D structure for fully understanding a scene. That is, machine vision strives to provide a high-level understanding of a surrounding environment, as performed by the human visual system.

Deploying autonomous agents in diverse, unstructured environments involves autonomous agents that operate with robust and general behaviors. Machine learning to train these autonomous agents often involves large, labeled datasets to reach state-of-the-art performance. Training the autonomous agents to enable robust, generalized behaviors involves generating and labeling large-scale datasets and using these datasets to train perception models. Unfortunately, acquiring a sufficient amount of training data can be laborious and costly, as it mostly relies on a large number of human annotators.

In addition, training methods for autonomous agents are strongly reliant on supervised training regimes. While supervised training regimes can provide for immediate learning of mappings from input to output, supervision involves large amounts of annotated datasets to accomplish the task. Unfortunately, acquiring these annotated datasets is laborious and costly. Additionally, the cost of annotating varies greatly with the annotation type because some annotation types (e.g., 3D bounding boxes) are much cheaper and faster to annotate than other annotation types (e.g., instance segmentations or cuboids).

Various aspects of the present disclosure are directed to producing useful annotations, such as training data for a machine learning model, from multi-modal (e.g., image, audio, trajectory) annotation inputs. In various implementations, the multi-modal annotation system includes a generative model that automatically produces coarse pre-annotations for fine refinement by other annotators. Furthermore, the multi-modal annotation system can implement various models for generating annotations. For instance, a multi-task learning model (e.g., supervised learning, unsupervised learning, etc.) for generating annotations significantly increases data efficiency while a discriminative model detects errors (e.g., a drift, a discrepancy). In some implementations, the multimodal annotation system combines manually annotated data with automatic annotations, in which more complex portions are first annotated. Additionally, the multimodal annotation system assigns a confidence score representing annotation quality.

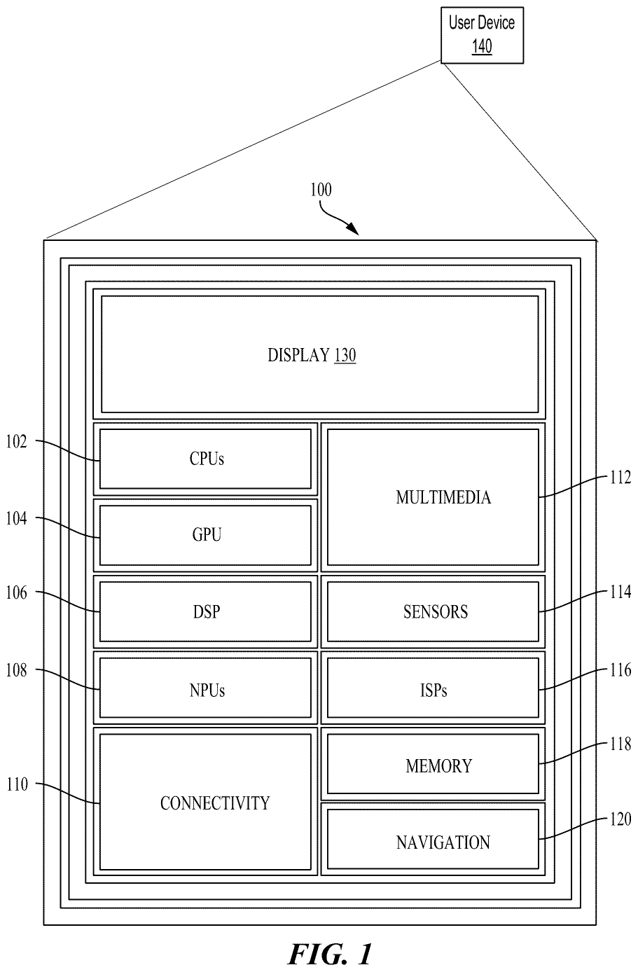

FIG. 1 illustrates an example implementation of the aforementioned system and method for a multi-modal annotation system using a system-on-a-chip (SOC) 100 of a user device 140. The SOC 100 may include a single processor or multi-core processors (e.g., a central processing unit (CPU) 102), in accordance with certain aspects of the present disclosure. Variables, system parameters associated with a computational device, delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) cellular network technology, fifth generation (5G) new radio (NR) technology, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risk Machine (ARM) instruction set or the like. Each processor core of the multi-core CPU 102 may be a reduced instruction set computing (RISC) machine, RISC-V, an advanced RISC machine (ARM), a microprocessor, or any reduced instruction set computing (RISC) architecture. The NPU 108 may be based on an ARM instruction set. In another aspect of the present disclosure, the SOC 100 may be a server computer in communication with the user device 140. In this arrangement, the user device 140 may include a processor and other features of the SOC 100.

In this aspect of the present disclosure, instructions loaded into a processor (e.g., the CPU 102) or the NPU 108 of the user device 140 may include program code to produce useful annotations, such as training data for a machine learning model, from multi-modal (e.g., image, audio, trajectory) annotation inputs. In various implementations, a multi-modal annotation system includes a generative model that automatically produces coarse pre-annotations for fine refinement by other annotators.

The instructions loaded into a processor (e.g., the NPU 108) may also include program code to generate, using a training data generation model and pre-annotated training data for human annotation. The instructions loaded into a processor (e.g., the NPU 108) may also include program code to iteratively verify the human annotation of the pre-annotated training data using a different annotator from a human annotator or the human annotation. The instructions loaded into a processor (e.g., the NPU 108) may also include program code to adjust the human annotations of the pre-annotated training data based on interactively verifying to finalize annotated training data to provide a finalized annotated training data. The instructions loaded into a processor (e.g., the NPU 108) may also include program code to train a machine learning model using the annotated training data.

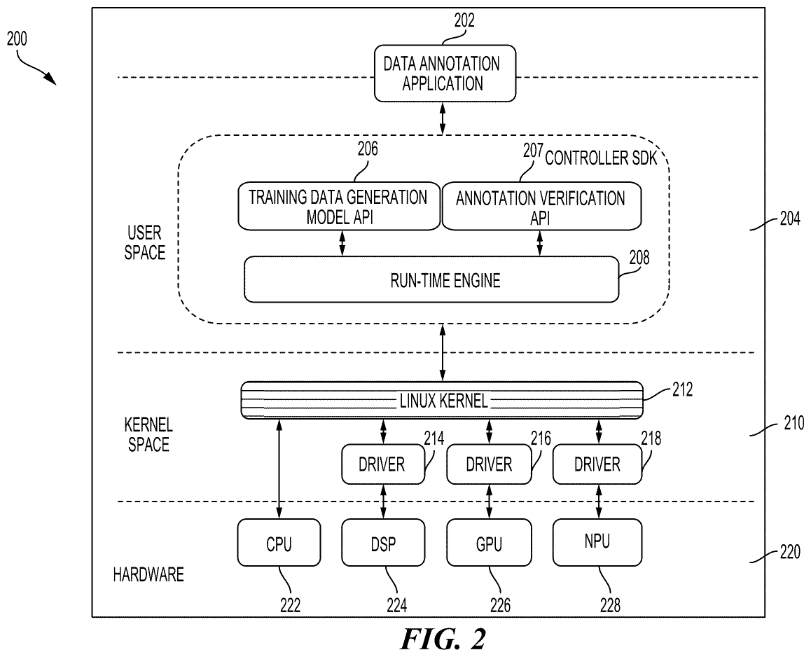

FIG. 2 is a block diagram illustrating a software architecture 200 that may modularize artificial intelligence (AI) functions for a multi-modal annotation system, according to aspects of the present disclosure. Using the software architecture 200, a data annotation application 202 may be designed such that it may cause various processing blocks of a system-on-a-chip (SOC) 220 (e.g., a CPU 222, a DSP 224, a GPU 226, and/or an NPU 228) to perform supporting computations during run-time operation of the data annotation application 202. While FIG. 2 describes the software architecture 200 for data annotation features, it should be recognized that the data annotation features are not limited to generating training data for autonomous agents. According to aspects of the present disclosure, the multi-modal annotation system is applicable to any machine learning model that involves training data.

The data annotation application 202 may be configured to call functions defined in a user space 204 that may, for example, produce useful annotations, such as training data for a machine learning model, from multi-modal (e.g., image, audio, trajectory) annotation inputs. The data annotation application 202 may make a request to compile program code associated with a library defined in a training data generation model application programming interface (API) 206 generate, using a training data generation model and pre-annotated training data for human annotation.

The data annotation application 202 may also make a request to compile program code associated with a library defined in an annotation verification API 207 to iteratively verify the human annotation of the pre-annotated training data using a different annotator from a human annotator or the human annotation. The annotation verification API 207 may also adjust the human annotations of the pre-annotated training data based on interactively verifying to finalize an annotated training data for training a machine learning model using the annotated training data.

A run-time engine 208, which may be compiled code of a runtime framework, may be further accessible to the data annotation application 202. The data annotation application 202 may cause the run-time engine 208, for example, to take actions for communicating with various annotators. When the annotations begin annotation of the initially generated annotation data, the run-time engine 208 may in turn send a signal to an operating system 210, such as a Linux Kernel 212, running on the SOC 220. FIG. 2 illustrates the Linux Kernel 212 as software architecture for producing useful annotations. It should be recognized, however, that aspects of the present disclosure are not limited to this exemplary software architecture. For example, other kernels may be used to provide the software architecture to support the automated training data generation functionality to produce useful annotations, such as training data for a machine learning model, from multi-modal (e.g., image, audio, trajectory) annotation inputs.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, a dynamic model may be configured to run on a combination of processing blocks, such as the CPU 222 and the GPU 226, or may be run on the NPU 228 if present.

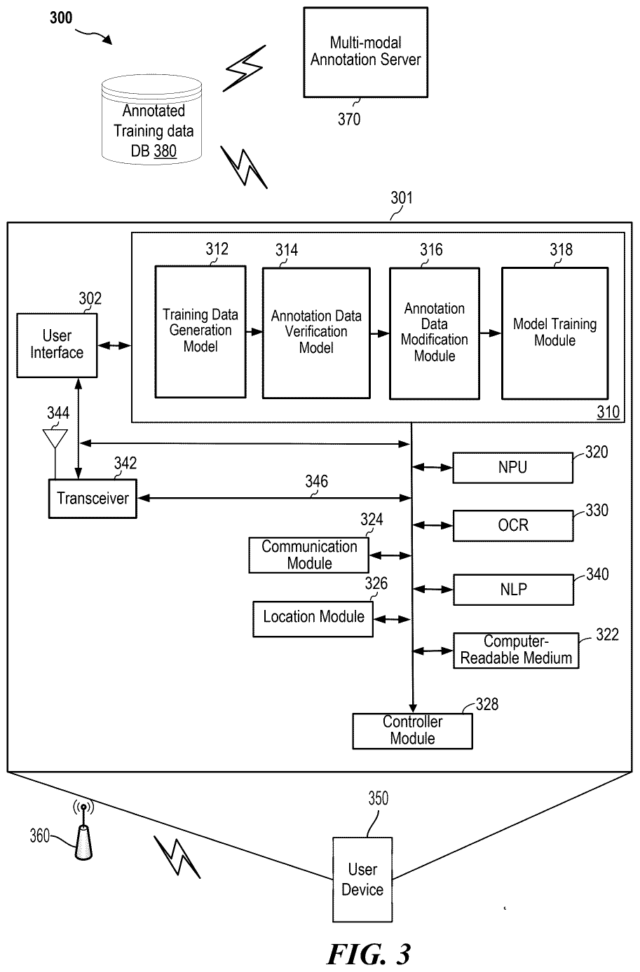

FIG. 3 is a diagram illustrating an example of a hardware implementation for a multi-modal annotation system 300, according to aspects of the present disclosure. The multi-modal annotation system 300 may be configured to produce useful annotations, such as training data for a machine learning model, from multimodal (e.g., image, audio, trajectory) annotation inputs. In various implementations, the multi-modal annotation system 300 includes a generative model that automatically produces coarse pre-annotations for fine refinement by other annotators.

The multi-modal annotation system 300 includes an annotation monitoring system 301 and a multi-modal annotation server 370, in this aspect of the present disclosure. The annotation monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet), an entertainment device (e.g., a music or video device, or a satellite radio), a global positioning system device, or any other suitable device that is configured to communicate via a wireless or wired medium.

According to various aspects of the present disclosure, the coarse pre-annotations are stored in an annotated training data database (DB) 380 for fine refinement by other annotators, such as through the multi-modal annotation server 370. The multi-modal annotation server 370 may connect to the user device 350 for annotations of the coarse pre-annotations stored in the annotated training data DB 380. In some implementations, the multi-modal annotation server 370 utilizes a generative model (e.g., a large language model (LLM)) to generate the coarse pre-annotations that are stored in the annotated training data DB 380. For example, the multi-modal annotation server 370 performs a verification of annotations of the course pre-annotations. If contradictory annotations are identified, the multi-modal annotation server 370 modifies the annotations, such that final, annotated training data is stored in the annotated training data DB 380. The multi-modal annotation system 300 may enable a generation of training data for autonomous vehicles or other like neural network model implementations.

The annotation monitoring system 301 may be implemented with an interconnected architecture, represented by an interconnect 346, which may be implemented as a controller area network (CAN). The interconnect 346 may include any number of point-to-point interconnects, buses, and/or bridges depending on the specific application of the annotation monitoring system 301 and the overall interactive persona design constraints. The interconnect 346 links together various circuits including one or more processors and/or hardware modules, represented by a user interface 302, a user activity module 310, a neural network processor (NPU) 320, a computer-readable medium 322, a communication module 324, a location module 326, a controller module 328, an optical character recognition (OCR) 330, and a natural language processor (NLP) 340. The interconnect 346 may also link various other circuits such as timing sources, peripherals, voltage regulators, and power management circuits, which are well known in the art, and therefore, will not be described any further.

The annotation monitoring system 301 includes a transceiver 342 coupled to the user interface 302, the user activity module 310, the NPU 320, the computer-readable medium 322, the communication module 324, the location module 326, the controller module 328, the OCR 330, and the NLP 340. The transceiver 342 is coupled to an antenna 344. The transceiver 342 communicates with various other devices over a transmission medium. For example, the transceiver 342 may receive commands via transmissions from a user. In this example, the transceiver 342 may receive/transmit information for the user activity module 310 to/from connected devices within the vicinity of the user device 350.

The annotation monitoring system 301 includes the NPU 320, the OCR 330, and the NLP 340 coupled to the computer-readable medium 322. The NPU 320, the OCR 330, and the NLP 340 performs processing, including the execution of software stored on the computer-readable medium 322 to provide a neural network model (e.g., a large language model (LLM)) to prune the annotated training data DB 380, according to various aspects of the present disclosure. The software, when executed by the NPU 320, the OCR 330, and the NLP 340, causes the annotation monitoring system 301 to perform the various functions described for pruning the annotated training data DB 380 based on contrary articles presented to the user through the user device 350, or any of the modules (e.g., 310, 324, 326, and/or 328). The computer-readable medium 322 may also be used for storing data that is manipulated by the OCR 330 and the NLP 340 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the user device 350 and/or the location module 326 compliant with one or more of the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 342. For example, the communication module 324 may be configured to provide communication capabilities via different wireless protocols, such as 6G, 5G new radio (NR), Wi-Fi, long term evolution (LTE), 4G, 3G, etc. The communication module 324 may also communicate with other components of the user device 350 that are not modules of the multi-modal annotation system 300. The transceiver 342 may be a communications channel through a network access point 360. The communications channel may include DSRC, 6G, 5G NR, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The annotation monitoring system 301 also includes the OCR 330 and the NLP 340 to automatically detect search results displayed on the user's workspace from the annotated training data DB 380. The annotation monitoring system 301 may follow a process to detect a drift or a discrepancy in the annotations. When the user performs a search from the annotated training data DB 380, the annotation monitoring system 301 utilizes the OCR 330 and/or the NLP 340 to analyze the annotations displayed on the user's workspace.

The annotation monitoring system 301 also includes the OCR 330 and the NLP 340 to automatically detect search results displayed on the user's workspace from the annotated training data DB 380. The annotation monitoring system 301 may follow a process to detect a drift or a discrepancy in the annotations. For example, when one annotation is produced from information from an image directory and another annotation is produced from audio information, the annotation monitoring can be configured to determine if these annotations are correct from a perspective of their intended use (e.g., for training data). When the annotators perform a search from the annotated training data DB 380, the annotation monitoring system 301 utilizes the OCR 330 and/or the NLP 340 to analyze the annotations displayed on the user's workspace.

Deploying autonomous agents in diverse, unstructured environments involves autonomous agents that operate with robust and general behaviors. Machine learning to train these autonomous agents often involves large, labeled datasets to reach state-of-the-art performance. Training the autonomous agents to enable robust, generalized behaviors involves generating and labeling large-scale datasets and using these datasets to train perception models. Unfortunately, acquiring a sufficient amount of training data can be laborious and costly, as it mostly relies on a large number of human annotators.

In addition, training methods for autonomous agents are strongly reliant on supervised training regimes. While supervised training regimes can provide for immediate learning of mappings from input to output, supervision involves large amounts of annotated datasets to accomplish the task. Unfortunately, acquiring these annotated datasets is laborious and costly. Additionally, the cost of annotating varies greatly with the annotation type because some annotation types (e.g., 3D bounding boxes) are much cheaper and faster to annotate than other annotation types (e.g., instance segmentations or cuboids).

According to various aspects of the present disclosure, the multi-modal annotation system 300 provides the ability to automatically produce annotations for initial training data, which significantly reduces a time specified for training a machine learning model. Additionally, the ability to produce annotations from multi-modal (e.g., image, audio, trajectory) inputs increases the population of sources for producing annotations. According to various aspects of the present disclosure, the multi-modal annotation system 300 is designed based on a recognition of the ability to annotate data (e.g., for training data for a machine learning model) using information from an image directory, audio information, etc. (i.e., beyond just textual information).

In some implementations, the multi-modal annotation system 300 is configured to generate multi-modal annotations and detect a drift or a discrepancy in the annotations. For example, when one annotation is produced from information from an image directory and another annotation is produced from audio information, a multi-modal annotation tool can be configured to determine if these annotations are correct from a perspective of their intended use (e.g., for training data).

As shown in FIG. 3, the multi-modal annotation system 300 includes the user activity module 310 that includes a training data generation model 312, an annotation data verification model 314, an annotation data modification module 316, and a model training module 318. The training data generation model 312 may be implemented using a large language model (LLM). The user activity module 310 is not limited to an LLM. The user activity module 310 enables production of useful annotations, such as training data for a machine learning model, from multi-modal (e.g., image, audio, trajectory) annotation inputs. In various implementations, the user activity module 310 includes a generative model that automatically produces coarse pre-annotations for fine refinement by other annotators.

The training data generation model 312 is configured to generate pre-annotated training data for human annotation. The annotation data verification model 314 is configured to iteratively verify the human annotation of the pre-annotated training data using a different annotator from a human annotator or the human annotation. The annotation data modification module 316 is configured to adjust the human annotations of the pre-annotated training data based on interactively verifying to finalize annotated training data. The model training module 318 is configured to train a machine learning model using the annotated training data.

As described in further detail below, the multi-modal annotation system 300 provides the ability to automatically produce annotations for training data, which significantly reduces a time specified for training a machine learning model. Additionally, the ability to produce annotations from multi-modal (e.g., image, audio, trajectory) inputs increases the population of sources for producing annotations. In some implementations, the multi-modal annotation system 300 combines manually annotated data with automatic annotations, in which more complex portions are first annotated. Additionally, the multi-modal annotation system 300 may assign a confidence score representing annotation quality.

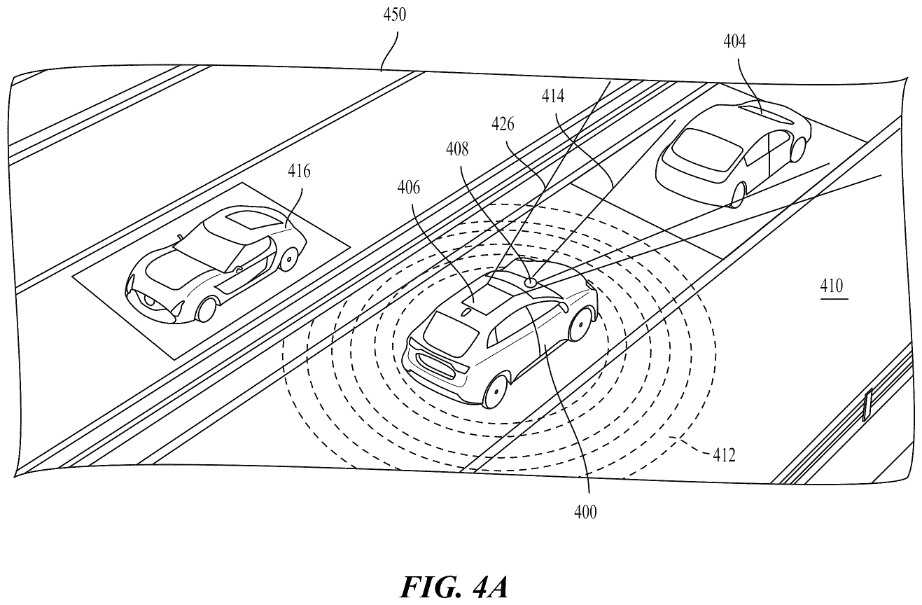

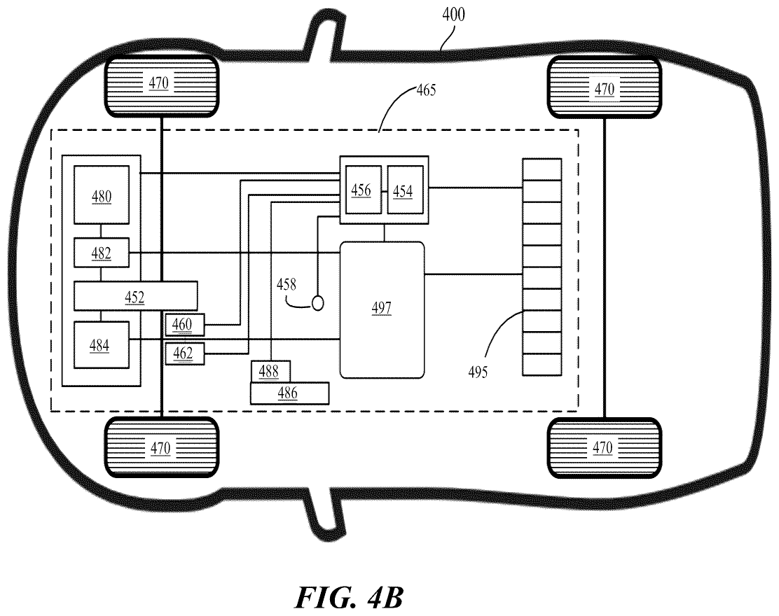

FIGS. 4A-4B are block diagrams illustrating a vehicle trained using training data generated with a multi-modal annotation system, according to aspects of the present disclosure.

FIG. 4A is a diagram illustrating an example of a vehicle 400 in an environment 450, in accordance with various aspects of the present disclosure. In the example of FIG. 4A, the vehicle 400 may be an autonomous vehicle, a semi-autonomous vehicle, or a non-autonomous vehicle. As shown in FIG. 4A, the vehicle 400 may be traveling on a road 410. A first vehicle 404 may be ahead of the vehicle 400 and a second vehicle 416 may be adjacent to the vehicle 400. In this example, the vehicle 400 may include a 2D camera 408, such as a 2D red-green-blue (RGB) camera, and a LIDAR sensor 406. The 2D camera 408 and the LIDAR sensor 406 may be components of an overall sensor system. Other sensors, such as radar and/or ultrasound, are also contemplated.

Additionally, or alternatively, although not shown in FIG. 4A, the vehicle 400 may include one or more additional sensors, such as a camera, a radar sensor, and/or a LIDAR sensor, integrated with the vehicle in one or more locations, such as within one or more storage locations (e.g., a trunk). Additionally, or alternatively, although not shown in FIG. 4A, the vehicle 400 may include one or more force measuring sensors.

In one configuration, the 2D camera 408 captures a 2D image that includes objects in the 2D camera's 408 field of view 414. The LIDAR sensor 406 may generate one or more output streams. The first output stream may include a three-dimensional (3D) cloud point of objects in a first field of view, such as a 360° field of view 412 (e.g., bird's eye view). The second output stream 424 may include a 3D cloud point of objects in a second field of view, such as a forward-facing field of view, such as the 2D camera's 408 field of view 414 and/or the 2D sensor's 406 field of view 426.

The 2D image captured by the 2D camera 408 includes a 2D image of the first vehicle 404, as the first vehicle 404 is in the 2D camera's 408 field of view 414. As is known to those of skill in the art, a LIDAR sensor 406 uses laser light to sense the shape, size, and position of objects in an environment. The LIDAR sensor 406 may vertically and horizontally scan the environment. In the current example, the artificial neural network (e.g., autonomous driving system) of the vehicle 400 may extract height and/or depth features from the first output stream. In some examples, an autonomous driving system of the vehicle 400 may also extract height and/or depth features from the second output stream 424.

The information obtained from the LIDAR sensor 406 and the 2D camera 408 may be used to evaluate a driving environment. In some examples, the information obtained from the LIDAR sensor 406 and the 2D camera 408 may identify whether the vehicle 400 is at an intersection or a crosswalk. Additionally, or alternatively, the information obtained from the LIDAR sensor 406 and the 2D camera 408 may identify whether one or more dynamic objects, such as pedestrians, are near the vehicle 400.

FIG. 4B is a diagram illustrating an example of a vehicle 400, in accordance with various aspects of the present disclosure. It should be understood that various aspects of the present disclosure may be directed to an autonomous vehicle. The autonomous vehicle may be an internal combustion engine (ICE) vehicle, fully electric vehicle (EV), or another type of vehicle. The vehicle 400 may include drive force unit 465 and wheels 470. The drive force unit 465 may include an engine 480, motor generators (MGs) 482 and 484, a battery 495, an inverter 497, a brake pedal 486, a brake pedal sensor 488, a transmission 452, a memory 454, an electronic control unit (ECU) 456, a shifter 458, a speed sensor 460, and an accelerometer 462.

The engine 480 primarily drives the wheels 470. The engine 480 can be an ICE that combusts fuel, such as gasoline, ethanol, diesel, biofuel, or other types of fuels which are suitable for combustion. The torque output by the engine 480 is received by the transmission 452. The MGs 482 and 484 can also output torque to the transmission 452. The engine 480 and the MGs 482 and 484 may be coupled through a planetary gear (not shown in FIG. 4B). The transmission 452 delivers an applied torque to one or more of the wheels 470. The torque output by the engine 480 does not directly translate into the applied torque to the one or more wheels 470.

The MGs 482 and 484 can serve as motors which output torque in a drive mode and can serve as generators to recharge the battery 495 in a regeneration mode. The electric power delivered from or to the MGs 482 and 484 passes through the inverter 497 to the battery 495. The brake pedal sensor 488 can detect pressure applied to the brake pedal 486, which may further affect the applied torque to the wheels 470. The speed sensor 460 is connected to an output shaft of the transmission 452 to detect a speed input which is converted into a vehicle speed by the ECU 456. The accelerometer 462 is connected to the body of the vehicle 400 to detect the actual deceleration of the vehicle 400, which corresponds to a deceleration torque.

The transmission 452 may be a transmission suitable for any vehicle. For example, the transmission 452 can be an electronically controlled continuously variable transmission (ECVT), which is coupled to the engine 480 as well as to the MGs 482 and 484. The transmission 452 can deliver torque output from a combination of the engine 480 and the MGs 482 and 484. The ECU 456 controls the transmission 452, utilizing data stored in the memory 454 to determine the applied torque delivered to the wheels 470. For example, the ECU 456 may determine that at a certain vehicle speed, the engine 480 should provide a fraction of the applied torque to the wheels 470 while one or both of the MGs 482 and 484 provide most of the applied torque. The ECU 456 and the transmission 452 can control an engine speed (NE) of the engine 480 independently of the vehicle speed (V).

The ECU 456 may include circuitry to control the above aspects of vehicle operation. Additionally, the ECU 456 may include, for example, a microcomputer that includes one or more processing units (e.g., microprocessors), memory storage (e.g., RAM, ROM, etc.), and I/O devices. The ECU 456 may execute instructions stored in memory to control one or more electrical systems or subsystems in the vehicle 400. Furthermore, the ECU 456 can include one or more electronic control units such as, for example, an electronic engine control module, a powertrain control module, a transmission control module, a suspension control module, a body control module, and so on. As a further example, electronic control units may control one or more systems and functions such as doors and door locking, lighting, human-machine interfaces, cruise control, telematics, braking systems (e.g., anti-lock braking system (ABS) or electronic stability control (ESC)), or battery management systems, for example. These various control units can be implemented using two or more separate electronic control units, or a single electronic control unit.

The MGs 482 and 484 each may be a permanent magnet type synchronous motor including, for example, a rotor with a permanent magnet embedded therein. The MGs 482 and 484 may each be driven by an inverter controlled by a control signal from the ECU 456, so as to convert direct current (DC) power from the battery 495 to alternating current (AC) power and supply the AC power to the MGs 482 and 484. In some examples, a first MG 482 may be driven by electric power generated by a second MG 484. It should be understood that in embodiments where MGs 482 and 484 are DC motors, no inverter is required. The inverter 497, in conjunction with a converter assembly, may also accept power from one or more of the MGs 482 and 484 (e.g., during engine charging), convert this power from AC back to DC, and use this power to charge the battery 495 (hence the name, motor generator). The ECU 456 may control the inverter 497, adjust driving current supplied to the first MG 482, and adjust the current received from the second MG 484 during regenerative coasting and braking.

The battery 495 may be implemented as one or more batteries or other power storage devices including, for example, lead-acid batteries, lithium ion and nickel batteries, capacitive storage devices, and so on. The battery 495 may also be charged by one or more of the MGs 482 and 484, such as, for example, by regenerative braking or coasting, during which one or more of the MGs 482 and 484 operates as a generator. Alternatively, or additionally, the battery 495 can be charged by the first MG 482, for example, when the vehicle 400 is idle (not moving/not in drive). Further still, the battery 495 may be charged by a battery charger (not shown) that receives energy from the engine 480. The battery charger may be switched or otherwise controlled to engage/disengage it with the battery 495. For example, an alternator or generator may be coupled directly or indirectly to a drive shaft of the engine 480 to generate an electrical current as a result of the operation of the engine 480. Still other embodiments contemplate the use of one or more additional motor generators to power the rear wheels of the vehicle 400 (e.g., in vehicles equipped with 4-Wheel Drive), or using two rear motor generators, each powering a rear wheel.

The battery 495 may also power other electrical or electronic systems in the vehicle 400. In some examples, the battery 495 can include, for example, one or more batteries, capacitive storage units, or other storage reservoirs suitable for storing electrical energy that can be used to power one or both of the MGs 482 and 484. When the battery 495 is implemented using one or more batteries, the batteries can include, for example, nickel metal hydride batteries, lithium-ion batteries, lead acid batteries, nickel cadmium batteries, lithium-ion polymer batteries, or other types of batteries.

The vehicle 400 may operate in one of an autonomous mode, a manual mode, or a semi-autonomous mode. In the manual mode, a human driver manually operates (e.g., controls) the vehicle 400. In the autonomous mode, an autonomous control system (e.g., autonomous driving system) operates the vehicle 400 without human intervention. In the semi-autonomous mode, the human may operate the vehicle 400, and the autonomous control system may override or assist the human. For example, the autonomous control system may override the human to prevent a collision or to obey one or more traffic rules.

The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle (e.g., Level 3 is a higher-level number than Levels 2 or 1), then the autonomous vehicle with a higher-level number offers a greater combination and quantity of autonomous features relative to the vehicle with the lower-level number. These distinct levels of autonomous vehicles are described briefly below.

Level 0: In a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (“ACC”); parking assistance with automated steering; and lane keeping assistance (“LKA”) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks but is still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the district where the vehicle is located).

A highly autonomous vehicle (“HAV”) is an autonomous vehicle that is Level 3 or higher. Accordingly, in some configurations the vehicle 400 is one of the following: a Level 1 autonomous vehicle; a Level 2 autonomous vehicle; a Level 3 autonomous vehicle; a Level 4 autonomous vehicle; a Level 5 autonomous vehicle; and an HAV.

Deploying the vehicle 400 in diverse, unstructured environments involves training the vehicle 400 to operate with robust and general behaviors. Machine learning to train the vehicle 400 often involves large, labeled datasets to reach state-of-the-art performance. Training the vehicle 400 to enable robust, generalized behaviors involves generating and labeling large-scale datasets and using these datasets to train perception models. Unfortunately, acquiring a sufficient amount of training data can be laborious and costly, as it mostly relies on a large number of human annotators.

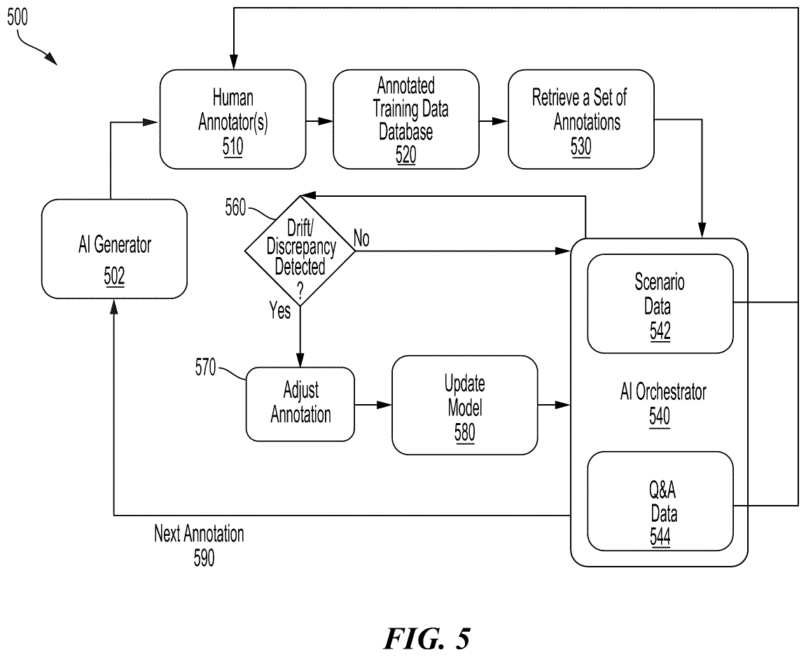

In addition, training methods for the vehicle 400 are strongly reliant on supervised training regimes. While supervised training regimes can provide for immediate learning of mappings from input to output, supervision involves large amounts of annotated datasets to accomplish the task. Unfortunately, acquiring these annotated datasets is laborious and costly. Additionally, the cost of annotating varies greatly with the annotation type because some annotation types (e.g., 3D bounding boxes) are much cheaper and faster to annotate than other annotation types (e.g., instance segmentations or cuboids). A multi-modal annotation process is shown, for example, in FIG. 5.

FIG. 5 is a block diagram illustrating a multi-modal annotation process 500, according to various aspects of the present disclosure. As shown in FIG. 5, components of the multi-modal annotation process 500 include an artificial intelligence (AI) generator 502, human annotators 510 (e.g., annotators in simulation rig and/or annotators on the WEB), and AI orchestrator 540. According to the multi-modal annotation process 500, the AI generator 502 automatically produces coarse pre-annotations for fine refinement by the human annotators, in which the annotated data is stored in an annotated training data database 520. Once annotated, an AI orchestrator 540 verifying annotation data, as described in further detail below.

For example, a generative model of the AI generator 502 generates partial answers, then the human annotators 510 complete the answers, which are stored in the annotated training data database 520. This process includes selecting a human annotation and generating a question based on the selected human annotation. Once an answer is received, this process includes verifying the selected human annotation based on an answer to the question. In some implementation, once stored, a set of annotations is retrieved at block 530 by the AI orchestrator 540. For example, the AI orchestrator 540 determines what annotations to prioritize, for example, by taking answers from AI and the human annotators 510 and asking another annotator/AI, a degree of importance of the annotated training data.

In this example, the AI orchestrator 540 includes scenario data 542 and Q&A data 544. For example, the scenario data 542 includes various types of data including, but not limited to image data, audio data, vehicle trajectory data, and/or human gaze, as well as other like scenario data. Sources of the scenario data 542 include (a) vehicle fleet data; (b) web videos, and/or (c) annotators riding in a simulator rig. Additionally, the Q&A data 544 includes questions and answers between the AI generator 502 and the human annotator(s) 510 as well as between the AI generator 502 and the AI orchestrator 540.

According to various aspects of the present disclosure, the Q&A interactions generate data (e.g., based on the scenario data 542 and the Q&A data 544) showing different scenarios which close the loop of the associated, scenario data 542. For example, one possible question includes “is this (visualization) an improved method for human interaction?” Additionally, for a coaching scenario, the question includes “is this practice going to be a better training example?” Additionally, visualization may generate data to annotate by the human annotator(s) 510. In some implementations, the human annotator(s) 510 utilize a web server for performing the annotations of the training data.

As further illustrated in FIG. 5, at block 560, the AI orchestrator 540 detects errors (e.g., a drift, a discrepancy, etc.) associated with the annotated training data retrieved at block 530. For example, the AI orchestrator 540 determines annotation correctness for an intended use (e.g., training data) when a first annotation is generated using an image directory and another annotation is generated with audio information. When an error is detected at block 560, the annotated training data is updated in block 570.

According to various aspects of the present disclosure, the AI generator 502 is configured with a generative model that produces coarse pre-annotations, which are sent to human annotator(s) 510 for fine refinement. In some implementations, the multi-modal annotation process 500 utilizes a learning model to improve the process of producing annotations, in which an update of the model is performed at block 580. For example, the multi-modal annotation process 500 use multitask learning (e.g., supervised, and unsupervised) to maximize data efficiency. Additionally, the multi-modal annotation process 500 uses a discriminative model to detect a drift or a discrepancy between annotations at block 560.

According to various aspects of the present disclosure, the multi-modal annotation process 500 uses a generative model of the AI generator 502 for automatic generation of annotations. In this example, the multi-modal annotation process 500 is configured to operate in an iterative manner with a next annotation 590. For example, in a set of data, ten percent can be manually annotated and based on this, the multi-modal annotation process 500 can annotate the remaining ninety percent. In this example, a most difficult portion of the set of data can be annotated first.

In some implementations, the AI orchestrator 540 determines a confidence score to judge a quality of the annotations. Additionally, the AI orchestrator 540 may gamify an environment for annotating multimodal data, such as a large language model (LLM) motivating annotators through competitive prompts having various context using the AI generator 502. The multi-modal annotation process 500 allows the human annotator(s) 510 to choose between modalities for allowing diverse interactions and follow-up questioning.

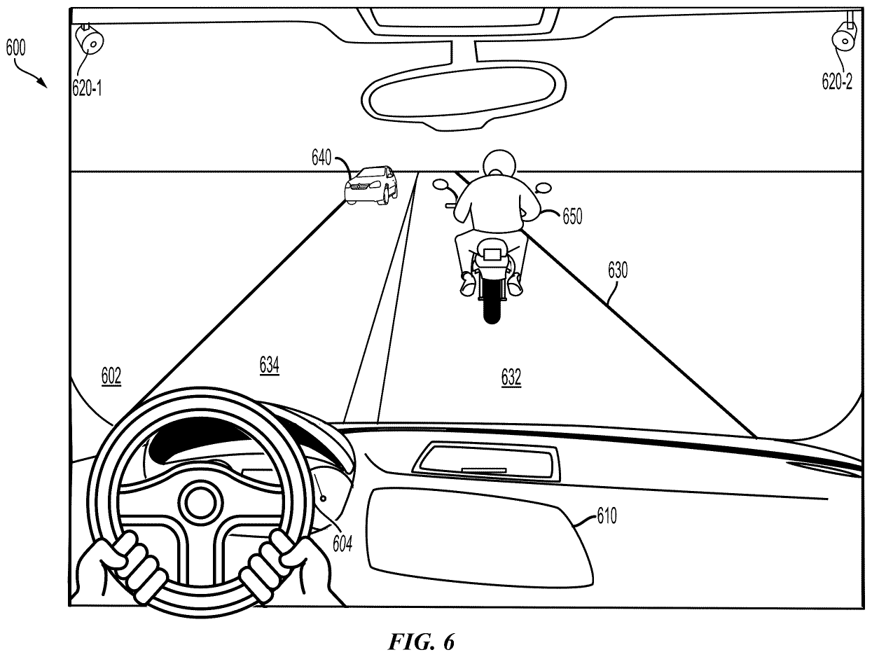

FIG. 6 illustrates scenario data for annotation, according to various aspects of the present disclosure. FIG. 6 illustrates a cabin of an ego vehicle 600, including a front-windshield 602, a steering wheel 604, cameras 620 (620-1, 620-2), and a heads-up display (HUD) 610, which enables the operator of the vehicle to monitor operation of the ego vehicle 600 and receive alerts. Video plays a key role in training, skill-improvement, and skill preparation. As shown in FIG. 6, a projection system is utilized for capturing vehicle-based driving data. In some implementations, the cameras 620 are utilized to acquire a driver's head pose to update the annotations from annotation of the training data based on operation of the ego vehicle 600.

In this example, the ego vehicle 600 is in a first lane 632 of a roadway 630, including a cycle 650 in the first lane 632 and an oncoming vehicle 640 in a second lane 634 of the roadway 630. As described, the cycle 650 and the oncoming vehicle 640 may be referred to as external road agents. In this training data, the ego vehicle 600 performs a lane violation, as the ego vehicle 600 is straddling a centerline and has crossed over from the first lane 632 to the second lane 634 of the roadway 630. In this example, a finalized training data is a driving scenario. Additionally, other driving scenarios include simulating driving on an icy road, performing a sudden stopping on a highway, and/or driving through an animal crossing of a road in darkness.

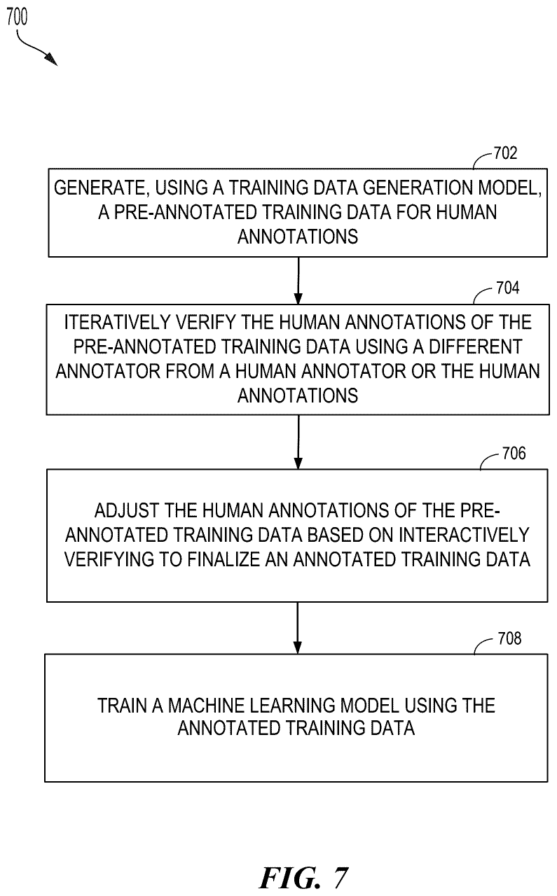

In this training data, the general location of the ego vehicle 600 is determined within the first lane 632 of the roadway 630. As the ego vehicle 600 slowly moves from the center of the first lane 632 and towards the second lane 634 and there is no indication that this movement is intended (e.g., turn signal has not been actuated, route guidance does not indicate that a lane change should be made, etc.) the training data may allow a model of the ego vehicle 600 to apply a mild amount of torque to the steering wheel 604 to reposition the ego vehicle 600 within the first lane 632. A multi-modal annotation process is illustrated, for example, in FIG. 7.

FIG. 7 is a flowchart illustrating a method 700 for a multi-modal annotation process, according to aspects of the present disclosure. The method 700 begins at block 702, in which a pre-annotated training data is generated for human annotations using a training data generation model. For example, as shown in FIG. 5, components of the multi-modal annotation process 500 include an artificial intelligence (AI) generator 502, human annotators 510 (e.g., annotators in simulation rig and/or annotators on the WEB), and AI orchestrator 540. According to the multi-modal annotation process 500, the AI generator 502 automatically produces coarse pre-annotations for fine refinement by the human annotators, in which the annotated data is stored in an annotated training data database 520.

At block 704, the human annotations of the pre-annotated training data are iteratively verified using a different annotator from a human annotator or the human annotations. For example, as shown in FIG. 5, once an answer is received, this process includes verifying the selected human annotation based on an answer to the question. In some implementation, once stored, a set of annotations is retrieved at block 530 by the AI orchestrator 540.

At block 706, the human annotations of the pre-annotated training data are adjusted based on interactively verifying to finalize an annotated training data. For example, as shown in FIG. 5, the AI orchestrator 540 determines what annotations to prioritize, for example, by taking answers from AI and the human annotators 510 and asking another annotator/AI, a degree of importance of the annotated training data.

At block 708, a machine learning model is trained using the annotated training data. For example, as shown in FIG. 5, In some implementations, the multi-modal annotation process 500 utilizes a learning model to improve the process of producing annotations, in which an update of the model is performed at block 580. For example, the multi-modal annotation process 500 use multitask learning (e.g., supervised, and unsupervised) to maximize data efficiency. Additionally, the multi-modal annotation process 500 uses a discriminative model to detect a drift or a discrepancy between annotations at block 560.

In some aspects of the present disclosure, the method shown in FIG. 7 may be performed by the SOC 100 (FIG. 1) or the software architecture 200 (FIG. 2) of the user device 140. That is, each of the elements or methods may, for example, but without limitation, be performed by the SOC 100, the software architecture 200, the processor (e.g., CPU 102), and/or other components included therein of the user device 140, or the multi-modal annotation system 300.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and nonlinear model predictive control described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and

variations may be made in the arrangement, operation, and details of the methods and apparatus described above without departing from the scope of the claims.

What is claimed is:

1. A method for multi-modal annotation, the method comprising:
generating, using a training data generation model, a pre-annotated training data for human annotations;
iteratively verifying the human annotations of the pre-annotated training data using a different annotator from a human annotator or the human annotations;
adjusting the human annotations of the pre-annotated training data based on interactively verifying to finalize an annotated training data; and
training a machine learning model using the annotated training data.

2. The method of claim 1, in which the training data generation model comprises a large language model (LLM).

3. The method of claim 1, in which an initial training data includes competitive prompts regarding the initial training data to receive the human annotations.

4. The method of claim 1, in which a finalized annotated training data includes image data, audio data, trajectory data, and/or a human gaze.

5. The method of claim 1, in which iteratively verifying comprises:
selecting a human annotation;
generating a question based on the human annotation; and
verifying the human annotation based on an answer to the question.

6. The method of claim 1, in which a finalized annotated training data comprises a driving scenario.

7. The method of claim 6, in which the driving scenario comprises simulating driving on an icy road, performing a sudden stopping on a highway, and/or driving through an animal crossing of a road in darkness.

8. The method of claim 1, further comprising:
verifying annotation data of the annotated training data when a first annotation is produced from information from an image directory and another annotation is produced from audio information; and
configuring a multi-modal annotation tool to determine if these annotations are correct from a perspective of their intended use.

9. A non-transitory computer-readable medium having program code recorded thereon for multi-modal annotation, the program code being executed by a processor and comprising:
program code to generate, using a training data generation model, a pre-annotated training data for human annotations;
program code to iteratively verify the human annotations of the pre-annotated training data using a different annotator from a human annotator or the human annotations;
program code to adjust the human annotations of the pre-annotated training data based on interactively verifying to finalize an annotated training data; and
program code to train a machine learning model using the annotated training data.

10. The non-transitory computer-readable medium of claim 9, in which the training data generation model comprises a large language model (LLM).

11. The non-transitory computer-readable medium of claim 9, in which an initial training data includes competitive prompts regarding the initial training data to receive the human annotations.

12. The non-transitory computer-readable medium of claim 9, in which a finalized annotated training data includes image data, audio data, trajectory data, and/or a human gaze.

13. The non-transitory computer-readable medium of claim 9, in which the program code to iteratively verify comprises:
program code to select a human annotation;
program code to generate a question based on the human annotation; and
program code to verify the human annotation based on an answer to the question.

14. The non-transitory computer-readable medium of claim 9, in which a finalized annotated training data comprises a driving scenario.

15. The non-transitory computer-readable medium of claim 14, in which the driving scenario comprises program code to simulate driving on an icy road, program code to perform a sudden stopping on a highway, and/or program code to drive through an animal crossing of a road in darkness.

16. The non-transitory computer-readable medium of claim 9, further comprising:
program code to verify annotation data of the annotated training data when a first annotation is produced from information from an image directory and another annotation is produced from audio information; and
program code to configure a multi-modal annotation tool to determine if these annotations are correct from a perspective of their intended use.

17. A system for multi-modal annotation, the system comprising:
a training data generation model to generate, using a training data generation model, a pre-annotated training data for human annotations;
an annotated data verification model to iteratively verify the human annotations of the pre-annotated training data using a different annotator from a human annotator or the human annotations;
an annotated data modification model to adjust the human annotations of the pre-annotated training data based on interactively verifying to finalize an annotated training data; and
a model training module to train a machine learning model using the annotated training data.

18. The system of claim 17, in which the training data generation model comprises a large language model (LLM).

19. The system of claim 17, in which an initial training data includes competitive prompts regarding the initial training data to receive the human annotations.

20. The system of claim 17, in which a finalized annotated training data includes image data, audio data, trajectory data, a human gaze, and/or a driving scenario.
